(19) United States
(12) Patent Application Publication
(10) Pub. No.: US 2025/0100124 A1
(43) Pub. Date: Mar. 27, 2025

(54) SCREW-LESS MAGNETIC HANDLE FOR OUTDOOR CUTTER

(71) Applicants: Zhaoxi HUANG, Guangzhou (CN); GUANGZHOU PIRATECH OUTDOOR, Guangzhou (CN)

(72) Inventor: Zhaoxi HUANG, Guangzhou (CN)

(21) Appl. No.: 18/971,658

(22) Filed: Dec. 6, 2024

Related U.S. Application Data
(63) Continuation of application No. PCT/CN2023/127155, filed on Oct. 27, 2023.

(30) Foreign Application Priority Data
Aug. 3, 2023 (CN) 202310968917.X

(51) Int. Cl. B25G 1/10; B26B 1/10

(52) U.S. Cl. CPC B25G 1/10; B26B 1/10

(57) ABSTRACT

A screw-less magnetic handle for an outdoor cutter is provided, relating to the technical field of cutter handle fixing technologies. A technical problem to be mainly solved is that it is difficult to replace and disassemble a cutter handle, for example, an existing screw fixing technology is prone to problems such as stripped screws and inconsistent screw specifications. Key points of a technical solution to this problem: 1. A magnetic force of internal magnets is used instead of a screw pressure for longitudinally locking handle parts. The magnetic force of a single handle part is 30 N to 150 N. 2. Lateral movement resistance provided by the screw to the handle part is replaced by a screw protrusion of an inner member and a corresponding close fit groove inside the handle part.

### CROSS-REFERENCE TO RELATED APPLICATION

This patent application is a direct entry US application, which claims the benefit and priority to Chinese Patent Application No. 202310968917.X, filed on Aug. 3, 2023 and incorporated by reference in its entirety. A related International Patent Application No. PCT/CN2023/127155 was filed on Oct. 27, 2023.

### TECHNICAL FIELD

The present disclosure relates to a cutter handle, and in particular, to a screw-less magnetic handle for an outdoor cutter.

### BACKGROUND

Handle parts of an existing folding cutter is fixed to a steel liner by screws or safety pins. A screw fixing technology is prone to problems such as stripped screws and inconsistent screw specifications. In addition, during cutter maintenance or handle replacement, a screwdriver needs to be used and multiple screws need to be removed, which leads to complicated steps, and makes it difficult to replace and disassemble the handle of the cutter. After being mounted back, the handle parts are fixed by screws again, but the blade centering and stability are not as great as it was delivered if the user is not as professional as manufacturer.

### SUMMARY

An objective of the present disclosure is to provide a screw-less magnetic handle for an outdoor cutter, to mainly solve the problem that during cutter maintenance or handle replacement, a screwdriver needs to be used and the complicated steps of removing multiple screws are needed, and after being mounted back, the handle parts are fixed by screws again, but the blade centering and stability are not as great as it was delivered if the user is not as professional as manufacturer.

In order to achieve the above objective, the present disclosure provides the following solutions. A screw-less magnetic handle for an outdoor cutter is provided, including handle parts and a steel liner, the handle parts are magnetically attracted handle parts, and are fixedly attracted to the steel liner by magnetic force of magnets embedded in the handle parts.

In an embodiment, a resultant magnetic force of one of the handle parts on one side of the steel liner is 30 N to 150 N.

Beneficial effects: A user can disassemble, clean and replace the handle without a screwdriver, which can reduce direct scrapping of the cutter caused by damage to the handle, stripped screws, or the like. In addition, since the handle part on each side is equipped with independent permanent magnets, the handle part can be disassembled or assembled independently. Therefore, the cutter can be maintained only by disassembling a single-sided handle part, making it more convenient to use and avoiding a case that during disassembly, when the handle part on one side has been taken apart, the entire cutter or the handle part on the other side falls apart and falls off.

Main use: The cutter handle can be disassembled, cleaned and replaced more conveniently while the cutter is still stable and safe in normal use, without a screwdriver, and with no need to worry about the problem that the handle cannot be disassembled after stripped screws occur.

### BRIEF DESCRIPTION OF THE DRAWINGS

FIG. 1 is an exploded view of a screw-less magnetic handle for an outdoor cutter according to an embodiment of the present disclosure;

FIG. 2 is a schematic diagram of an entire structure of a screw-less magnetic handle for an outdoor cutter according to an embodiment of the present disclosure; and

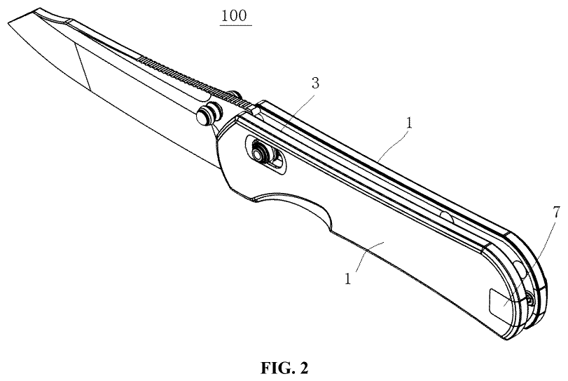

FIG. 3 is a schematic partial exploded view of a screw-less magnetic handle for an outdoor cutter according to an embodiment of the present disclosure.

In the drawings, reference signs: 100 screw-less magnetic handle for an outdoor cutter; 1 handle part; 2 permanent magnet; 3 steel liner; 4 positioning groove; 5 groove for magnet; 6 cylindrical flat-headed pivot screw; 7 filler tap; 8 pocket clip.

### DETAILED DESCRIPTION OF THE EMBODIMENTS

### Embodiment 1

Provided is a screw-less magnetic handle 100 for an outdoor cutter. A vertical magnetic force of permanent magnets 2 embedded in grooves for magnets 5 inside a handle part 1 is used to replace a vertical locking tensile force/pressure of a screw or a safety pin. At least three positioning structures are arranged between the handle part 1 and a steel liner 3. Each positioning structure includes an adaptive cylindrical flat-headed pivot screw 6 and a positioning groove 4. The cylindrical flat-headed pivot screw 6 is fixed to the steel liner 3, and the positioning groove 4 is formed in the handle part 1. After being magnetically fixed to the steel liner 3 by the permanent magnets 2, the handle part 1 is positioned by concave-convex fit between the positioning groove 4 and the cylindrical flat-headed pivot screw 6, so that the handle part 1 can be prevented from sliding laterally relative to the steel liner 3. In a preferred solution, three positioning structures are provided between the handle part 1 on each side and the steel liner 3, and the three positioning structures are dispersed. The three positioning structures should be the three vertices of a triangle. With this stable positioning design of the triangle, a lateral locking force of a screw or a safety pin can be replaced, so that the handle part 1 on each side can be independently and normally fixed to the steel liner 3, with no need to be fitted and assembled with the handle part 1 on the other side by a safety pin, a buckle, a screw, or the like. Dismantling and maintenance of the cutter or replacement of the handle part 1 does not need the use of a screwdriver and only needs to hold edges of the handle parts 1 by hands and pull it apart diagonally through leverage. In addition, the single-sided handle part 1 can be disassembled independently without a safety pin, a buckle and a screw, thereby avoiding a case that during disassembly, when the handle part on one side has been taken apart, the entire cutter or the handle part on the other side falls apart and falls off.

A single-sided handle part 1 is magnetically fixed by four permanent magnets 2, with a total vertical resultant force of approximately 75 N, sufficient for any usage scenario in a normal usage environment. The four permanent magnets 2 are evenly distributed on the handle part 1, which can ensure that the handle part 1 is uniformly stressed.

Optimally, the handle part 1 and an inner member are machined by a CNC machine with machining tolerances of less than 0.02 mm to ensure that the handle part 1 does not have a displacement clearance to ensure that the above positioning structures fully achieves effects. N52 magnets with highest specifications are used as the permanent magnets 2 to ensure that a magnetic force is sufficient to keep the handle part 1 from separating from the steel liner 3 of a cutter body while a single-sided handle part is held to be swung, and that the handle is stable and durable.

The grooves for magnets 5 are machined in the handle parts 1 by the CNC machine to internally provide the permanent magnets 2, and a stainless steel inner member is used as the steel liner 3 to cause the permanent magnets 2 to be attracted to the handle parts.

The positioning grooves 4 are machined in the handle parts 1 by the CNC machine to embed tops of the cylindrical flat-headed pivot screws 6, so that the handle parts 1 can be prevented from sliding after being attracted.

Industrial applicability: A vertical tensile force of a screw or a pin shaft is replaced by a vertical magnetic force of magnets, and a positioning structure formed by the positioning groove 4 and the cylindrical flat-headed pivot screw 6 is used as a locking column to replace a lateral locking force of the screw, so as to meet structural requirements for simplification and optimization of some tool screws in industrial use and therefore simplify assembly and disassembly steps of the cutter handle.

The present disclosure is used to simplify the steps of assembling and disassembling a cutter handle and meet requirements for removing a screw to cause the appearance to be more in line with modern aesthetics, and is a simplified design of new functions for optimizing cutter use experience. Key points of the technical solution: 1. A magnetic force of internal magnets is used to replace a screw pressure for longitudinally locking the handle parts. The magnetic force of a single handle part of the handle is 30 N to 150 N. 2. Lateral movement resistance provided by the screw to the handle part is replaced by the cylindrical flat-headed pivot screw 6 corresponding to the positioning groove 4. Main use: The cutter handle can be disassembled, cleaned and replaced more conveniently while the cutter is still stable and safe in normal use, without a screwdriver, and with no need to worry about the problem that the handle cannot be disassembled after stripped screws occur.

### Embodiment 2

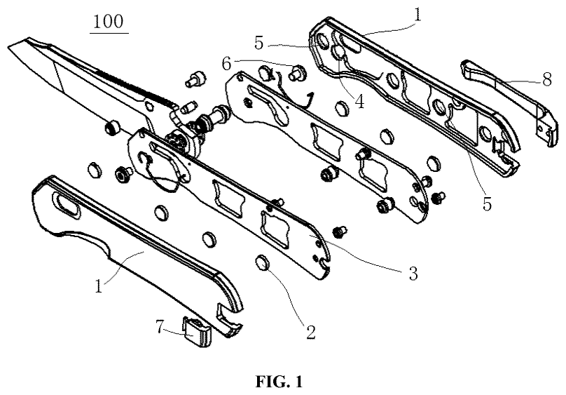

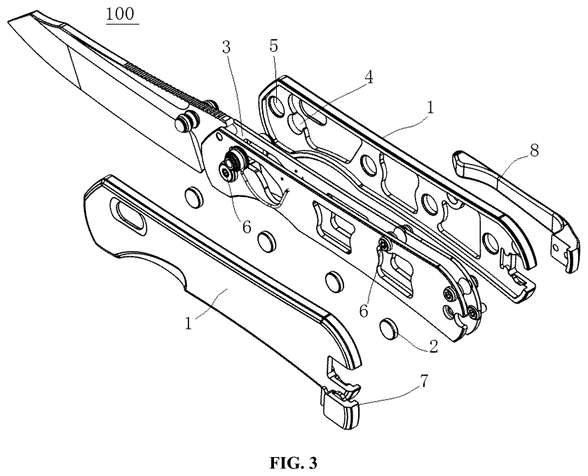

A screw-less magnetic handle 100 for an outdoor cutter according to this embodiment is further provided with a filler tap 7 and a pocket clip 8 on the basis of Embodiment 1. As shown in FIGS. 1 and 3, handle parts 1 are symmetrically magnetically attracted to two sides of a steel liner 3 of the cutter. A pommel of the handle part on one side is provided with a snap-fit groove, and the pocket clip 8 is detachably snap-fitted in the snap-fit groove, so that screw-free mounting of the pocket clip 8 is implemented. The handle parts on two sides of the steel liner 3 have the same structure and are symmetric, so that a pommel of the handle part on the other side of the steel liner 3 has the same snap-fit groove, and the filler tap 7 with a suitable shape is clamped in the snap-fit groove, thereby implementing screw-free mounting of the filler tap 7. The filler tap 7 is fixed in a snap-fitted mode, which facilitates assembly on and disassembly from the handle part 1, and the filler tap 7 can be removed more conveniently when left and right directions of a pocket clip are changed.

To improve structural stability of the pocket clip 8, the pocket clip 8 and the steel liner 3 are further threadedly reinforced by a screw. Preferably, the screw is screwed into the pocket clip 8 from inside/underneath, so that there is no screw in appearance.

### Embodiment 3

A screw-less magnetic handle 100 for an outdoor cutter according to this embodiment differs from Embodiment 1 in that a positioning groove 4 of a positioning structure is formed in the steel liner 3, and a positioning protrusion is arranged on the handle part 1.

In the present disclosure, the principle and embodiments of the present disclosure are described by specific examples, and the above descriptions of the embodiments are merely intended to help understand the method and core idea of the present disclosure. In addition, for those of ordinary skill in the art, changes may be made to specific implementations and the scope of application according to the concept of the present disclosure. In summary, the content of the description should not be construed as a limitation to the present disclosure.

What is claimed is:

1. A screw-less magnetic handle for an outdoor cutter, comprising handle parts and a steel liner, wherein the handle parts are magnetically attracted handle parts, and are fixedly attracted to the steel liner by magnetic force of magnets embedded in the handle parts.

2. The screw-less magnetic handle for the outdoor cutter according to claim 1, wherein a resultant magnetic force of one of the handle parts on one side of the steel liner is 30 N to 150 N.

3. The screw-less magnetic handle for the outdoor cutter according to claim 1, wherein grooves for magnets are formed at an inner side of the handle parts, and the magnets are embedded in the grooves for magnets.

4. The screw-less magnetic handle for the outdoor cutter according to claim 1, wherein the magnets are permanent magnets.

5. The screw-less magnetic handle for the outdoor cutter according to claim 1, wherein at least three positioning structures are arranged between each of the handle parts and the steel liner, each of the positioning structures comprises a positioning protrusion and a positioning groove matched with the positioning protrusion, the positioning protrusion is arranged on the steel liner, and the positioning groove is formed in each of the handle parts.

6. The screw-less magnetic handle for the outdoor cutter according to claim 5, wherein the positioning protrusion is a cylindrical flat-headed pivot screw.

7. The screw-less magnetic handle for the outdoor cutter according to claim 6, wherein three positioning structures are arranged between each of the handle parts and the steel liner, and the three positioning structures are three vertices of a triangle.

8. The screw-less magnetic handle for the outdoor cutter according to claim 6, wherein at least four positioning structures are arranged between each of the handle parts and the steel liner, and the at least four positioning structures are vertices of a polygon.

9. The screw-less magnetic handle for the outdoor cutter according to claim 1, wherein at least three positioning structures are arranged between each of the handle parts and the steel liner, each of the positioning structures comprises a positioning protrusion and a positioning groove matched with the positioning protrusion, the positioning protrusion is arranged on each of the handle parts, and the positioning groove is formed in the steel liner.

10. The screw-less magnetic handle for the outdoor cutter according to claim 1, wherein the handle parts are magnetically attracted to two sides of the steel liner symmetrically, a snap-fit groove is formed in a pommel of one of the handle parts on one side, and a pocket clip is snap-fitted in the snap-fit groove; and the handle parts on two sides have the same structure, and a filler tap is snap-fitted in a snap-fit groove of an other one of the handle parts on an other side.
